(19) United States
(12) Patent Application Publication
(10) Pub. No.: US 2019/0100054 A1
(43) Pub. Date: Apr. 4, 2019

(54) MANUFACTURING METHOD AND DEVICE FOR A FOAM FILLED TIRE

(71) Applicant: Ting-Wei Chang, New Taipei City (TW)

(72) Inventor: Ting-Wei Chang, New Taipei City (TW)

(21) Appl. No.: 15/723,176

(22) Filed: Oct. 3, 2017

(51) Int. Cl. B60C 7/10; B29D 30/04; B29C 73/16

(52) U.S. Cl. CPC B60C 7/105; B29C 73/166; B29D 30/04

(57) ABSTRACT

A manufacturing method and device for a foam filled tire comprises the following steps: a. taking off a gas nozzle check valve of the tire; b. setting foaming materials in a destined proportion; c. mixing the foaming materials into filling materials, then placing into an inner space of the tire; d. covering the gas nozzle check valve after a destined time; e. filling the inner space of the tire after finishing the foaming process. Thereby it is achieved that the tire will not leak and support a car steadily.

### FIELD OF THE INVENTION

The present invention relates to a manufacturing method and device for a foam filled tire, particularly to a manufacturing method and device for a foam filled tire, wherein foaming raw materials are disposed within the tire as filling materials to support a car.

### BACKGROUND OF THE INVENTION

Now a day car is convenient for everyday life. A conventional air filled car wheel is usually constructed of steel ring, tire and air, wherein resilient support is used to reduce quake.

However, once a tire is damaged, even with a little hole pierced in the tire, air can leak out and support of the tire is failed.

Besides, during driving, accidents can happen easily, if a tire is damaged. In worst case serious accidents happen due to puncture, as result, lives of drivers and passers-by are endangered. According to the World Traffic Safety Commission, Traffic accidents amount to 27% due to damaged tire, while serious traffic accidents amount to 67% due to puncture. Obviously, tires are important for traffic safety.

In view of these disadvantages the inventor tried the continuous testing and improvement and developed the present invention.

### SUMMARY OF THE INVENTION

The main object of the present invention is to provide a manufacturing method for a foam filled tire, wherein the tire cannot leak and wherein the tire can support a car steadily, even it is damaged.

For achieving above object, the present invention comprises the following steps: a. taking off a gas nozzle check valve of the car wheel; b. distributing several foaming raw materials in a destined proportion; c. mixing the several foaming raw materials into filling materials, then injecting into the inner space of a tire; d. covering the gas nozzle check valve after a destined time; e. filling the inner space of a tire after finishing the foaming process. Thereby it is achieved that the tire will not leak and support a car steadily, even the tire is damaged.

Another object of the present invention is to provide a device for a foam filled tire, wherein the tire will not leak and support a car steadily, even the tire is damaged.

For achieving above object, this device comprises: a main body, having an inner space; a foaming raw materials output system, setting in the inner space of the main body, for exporting several foaming raw materials; a perfusion system, for mixing the several foaming raw materials exported from the output system into filling material, then injecting into the inner tire; distributing several foaming raw materials in a destined proportion through the forming raw materials output system, then mixing the foaming materials into filling material and injecting into the inner tire through the perfusion system, let the filling materials foam and fill the inner space of a tire. Thereby it is achieved that the tire will not leak and support a car steadily.

Other aspects and advantages of the present invention will become apparent from the following detailed description, taken in conjunction with the accompanying drawing, illustrating by way of example the principles of the present invention.

### BRIEF DESCRIPTION OF THE DRAWING

FIG. 1 shows the flow chart of the present invention.

FIG. 2 shows the structure of the present invention.

FIG. 3 shows the structure of the foaming raw materials output system in the present invention.

### DESCRIPTION OF THE PREFERRED EMBODIMENTS

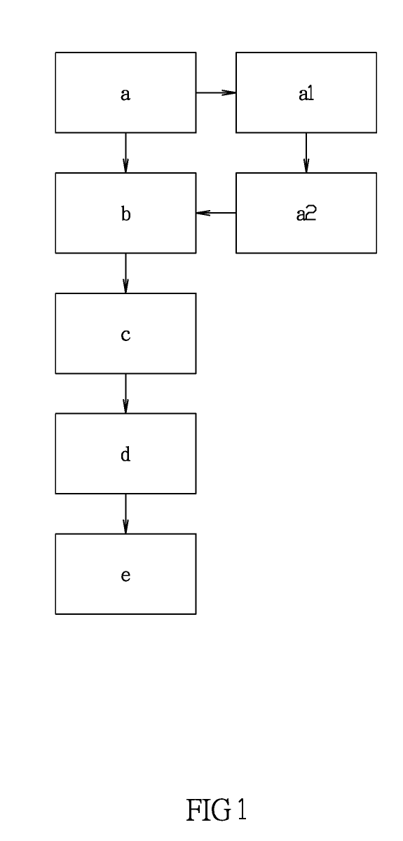

As shown in FIG. 1, A manufacturing method for a foam filled tire of the present invention comprises following steps: a. taking off a gas nozzle check valve of the tire; b. distributing several foaming raw materials in a destined proportion; c. mixing the several foaming raw materials into filling materials, then injecting into an inner space of the tire; d. covering the gas nozzle check valve after a destined time; e. filling the inner space of the tire after finishing the foaming process. Thereby it is achieved that the tire will not leak and support a car steadily.

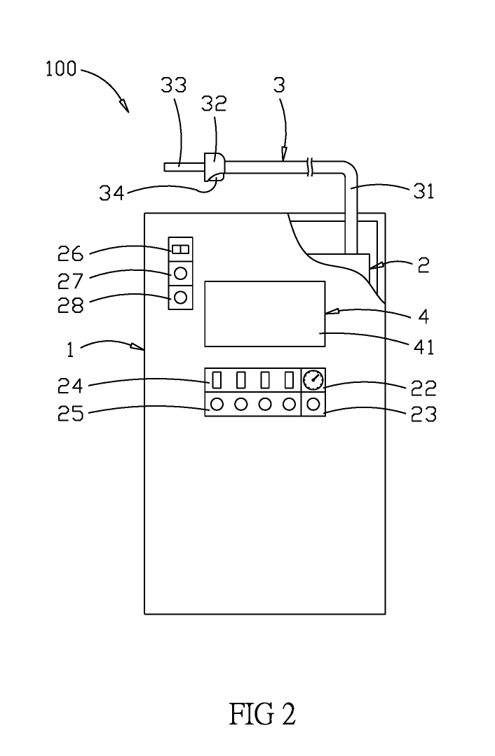

As shown in FIG. 2, according to the said manufacturing method for a foam filled tire, the present invention provides a device for a foam filled tire 100, comprising: a main body with an inner space; a foam raw materials output system 2, set in the space of the main body 1, exporting the several foaming raw materials; a perfusion system 3, mixing the foaming materials from the foaming raw materials output system 2 into filling materials, then injecting in the inner space of a tire of a car wheel (not shown); wherein the several foaming raw materials are distributed in destined proportion through the foaming raw materials output system 2, then the several foaming raw materials are mixed into filling materials and injected in the inner space of a tire through the perfusion system 3, let the filling materials foam and fill the inner space of a tire. Thereby it is achieved that the tire will not leak and support a car steadily.

The main body 1 is the carrier of foaming raw materials output system 2 and the perfusion system 3. It is a box body with an inner space.

The foaming raw materials output system 2 is set in the inner space of the main body 1, wherein several foaming raw materials are exported in destined proportion.

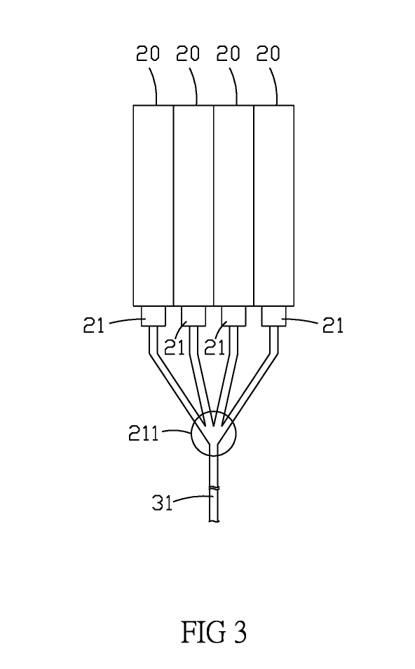

As shown in FIG. 3, the foaming raw materials output system 2 is constructed of four storage buckets 20, wherein each storage bucket 20 has an electromagnetic valve 21 for controlling output amount and output rate of raw materials, whereby the foaming materials mix in the mixing area 211 evenly. Therein the power of the foaming raw materials output system 2 is atmospheric pressure (not shown).

The several foaming raw materials of the present invention comprise: 5˜18 weight % foaming agents (like HFC-245; 1.1.1.3.3-Pentafluoropropane), 9˜25 weight % antioxidants (likeBHT), 30˜60 weight % foam stabilizers (like Tegostab B8462) and 20˜25 weight % catalysts (like Dabco TMR-4).

A perfusion system 3 comprises: a feeding tube 31, connecting a foaming raw materials output system 2 at bottom, to transport the several foaming raw materials exported from the foaming raw materials output system 2; a gun tip 32, set on the front of the feeding tube 31; a gas nozzle 33, set on the front of the gun tip 32, connected with the gas nozzle of a car wheel; a perfusion valve 34, set above the gun tip 32, to control the gun tip 32 injecting the several foaming raw materials into the inner tire of the car wheel. Thereby it is achieved, that the tire will not leak and support a car steadily.

Besides, as shown in FIG. 1, the present invention is applied to available various car wheels. However, available various car wheels and car types are different. Demands for tires are also different. Therefore, after the step a can process firstly: a1. getting car wheel application data; a2. defining the proportion of the several foaming raw materials according to the car wheel application data, thereafter processing the steps b˜e.

As shown in FIG. 2, since the proportion of the several foaming raw materials is defined according to car wheel application data, the foaming raw materials output system 2 is further connected with a control device 4.

The control device 4 is a touch screen, set within the space of the main body 1, wherein a screen end 41 is set on the front side of the main body 1 to enter the car wheel application data, whereby the proportion of the several foaming raw materials is defined according to the car wheel application data. Therein the car wheel application data comprises: car wheel types and vehicle types.

Furthermore, the foaming raw materials output system 2 has further various warning systems, comprising: a pressure gauge 22, set on the front side of the main body 1, wherein the pressure to export the several foaming raw materials is shown; a pressure warning light 23, set on the front side of the main body 1, connected with the pressure gauge 22, wherein the pressure warning light 23 lights up, once, detected by the pressure gauge 22, the pressure is insufficient; a raw material inventory 24, set on the front side of the main body 1, wherein stock of the several foaming raw materials in the foaming materials output system 2 is shown; a stock warning light 25, set on the front side of the main body 1, wherein the stock warning light 25 lights up, once, detected by the raw materials inventory 24, the stock of the several foaming raw materials is insufficient,

Besides, control devices, a switch 26, a start button 27 and a stop button 28 can also be set in the present invention.

Furthermore, after the step e of the present invention, data, like the car wheel application data and proportion of the several foaming raw material are saved for reference in future.

1. A manufacturing method for a foam filled tire, comprises the following steps:
a. taking off a gas nozzle check valve of the tire;
b. distributing several foaming raw materials according to destined proportion;
c. mixing the several foaming raw materials into filling materials, then injecting into the inner tire of a car wheel;
d. covering the gas nozzle check valve after destined time;
e. filling the inner space of the tire after finishing the foaming process.

2. The manufacturing method for the foam filled tire of claim 1, wherein the several foaming raw materials of the filling materials comprise: foaming agents, antioxidants, foam stabilizers and catalysts.

3. The manufacturing method for the foam filled tire of claim 2, wherein the foaming agent has 5˜18 weight % of the filling materials; antioxidants 9˜25 weight %; foam stabilizers 30˜60 weight %; catalysts 20˜25 weight %.

4. The manufacturing method for the foam filled tire of claim 1, wherein after the step a processes: a1. getting the car wheel application data; a2. defining the proportion of the several foaming raw materials according to the car wheel application data; then processing the steps b˜e.

5. The manufacturing method for the foam filled tire of claim 4, wherein the car wheel application data comprise: car wheel types and vehicle types.

6. A foam filled tire device, comprises:
a main body, having an inner space;
a foaming raw materials output system, set in the space of the main body, to export the several foaming raw materials;
a perfusion system, for mixing the several foaming raw materials from the foaming raw materials output system into filling material, then injecting into the inner tire of a car wheel;
wherein the several foaming raw materials are distributed through the foaming raw materials output system in destined proportion, then the several foaming raw materials are mixed into filling materials through the perfusion system, then injected into the inner tire, whereby the filling materials are foamed and filled in the inner tire and whereby it is achieved that the tire will not leak and support a car steadily.

7. The foam filled tire device of claim 6, wherein the several foaming raw materials of the filling materials comprise: foaming agents, antioxidants, foam stabilizers and catalysts.

8. The foam filled tire device of claim 7, wherein the foaming agent has 5˜18 weight % of the filling materials; antioxidants 9˜25 weight %; foam stabilizers 30˜60 weight %; and catalysts 20˜25 weight %.

9. The foam filled tire device of claim 6, wherein the perfusion system comprises: a feeding tube, connected with the foaming raw materials output system at the bottom, for exporting the several foaming raw materials of the foaming raw materials output system; a gun tip, set on the front of the feeding tube; a gas nozzle, set on the front of the gun tip, connecting with the gas nozzle of a car wheel; a perfusion valve, set up the gun tip, to control the gun tip injecting the several foaming raw materials into the inner tire of the car wheel.

10. The foam filled tire device of claim 6, wherein the foaming raw materials output system is connected with a control device; wherein the control device is a touch screen, set in the space of the main body, wherein a screen end is set on the front side of the main body to enter car wheel application data, whereby the proportion of the several foaming raw materials, exported by the foaming raw materials output system, is defined according to the car wheel application data.

11. The foam filled tire device of claim 10, wherein the car wheel application data comprise: car wheel types and vehicle types.
